(19) United States
(12) Patent Application Publication
(10) Pub. No.: US 2024/0430575 A1
(43) Pub. Date: Dec. 26, 2024

(54) PANORAMA IMAGE GENERATOR, METHOD AND PROGRAM

(71) Applicant: Nippon Telegraph and Telephone Corporation, Tokyo (JP)

(72) Inventors: Hiromu Miyashita, Musashino-shi, Tokyo (JP); Daisuke SATO, Musashino-shi, Tokyo (JP); Masato FUKUDA, Musashino-shi, Tokyo (JP); Shinji FUKATSU, Musashino-shi, Tokyo (JP); Hidenobu Nagata, Musashino-shi, Tokyo (JP)

(21) Appl. No.: 18/687,545

(22) PCT Filed: Sep. 2, 2021
(86) PCT No.: PCT/JP2021/032298

§ 371 Date: Feb. 28, 2024

(51) Int. Cl. H04N 23/698; G06T 3/4038

(52) U.S. Cl. CPC H04N 23/698; G06T 3/4038

(57) ABSTRACT

A panoramic image generation device includes an alignment processing unit 10 that generates a panoramic image by combining a plurality of divided images A to D captured by a plurality of imaging devices such that partial regions overlap and generates a coordinate table 11in which coordinates of each of the divided images A to D are associated with coordinates of the panoramic image; a luminance adjustment unit 20 that refers to the coordinate table 11, obtains a luminance magnification indicating a ratio of luminance values of pixels of two (A and B, B and C, and C and D) divided images having an overlapping region, and generates a luminance adjustment coefficient that levels a luminance difference indicated by the luminance magnification; and an image combining unit 30that generate a panoramic image by adjusting the luminance difference between the divided images and combining the divided images using the coordinate table 11, the luminance adjustment coefficient, and the divided images.

### TECHNICAL FIELD

The present invention relates to a panoramic image generation device, a panoramic image generation method, and a panoramic image generation program.

### BACKGROUND ART

A panoramic image generation device is known as a device that generates a wider angle panoramic image by combining images captured by a plurality of cameras such that partial regions thereof overlap. Such a panoramic image generation device matches feature points included in frame images, detects matching points at which the same subject appears, and combines the frame images based on the matching points.

Patent Literature 1 discloses a method in which a plurality of cameras is installed such that photographed regions partially overlap, and seam information indicating joining lines at which a plurality of high-resolution images obtained from the cameras are combined is acquired.

In addition, Non Patent Literature 1 discloses a system in which it is intended to collect ambient light at the central portion of an imaging system to capture light reflected on a mirror installed with a certain angle by using a plurality of cameras although there is a restriction that there is required to be a certain distance or greater between the imaging target and the cameras.

### CITATION LIST

### Patent Literature

Patent Literature 1: JP 2018-26744 A

### Non Patent Literature

Non Patent Literature 1: C. Weissig, et al. “The Ultimate Immersive xperience: Panoramic 3D Video Acquisition”, International Conference on Multimedia Modeling, pp. 671-681, 2012.

https://link.springer.com/content/pdf/10.1007% 2F978-3-642-27355-1.pdf

### SUMMARY OF INVENTION

### Technical Problem

However, in the techniques disclosed in Patent Literature 1 and Non Patent Literature 1, the focal centers are different in each of the plurality of cameras, and thus there is parallax. For this reason, when seam information is set based on feature points of a subject located at a certain depth, a double image or a defect may occur between the aforementioned subject and a subject located at a different depth on the panoramic image.

Furthermore, each of the plurality of cameras may have different gains and shutter speeds of the imaging elements (image sensors), and the brightness, hue, and the like of the images may greatly vary with the seam information as a boundary, which leads to deterioration of the viewing quality of the panoramic image. As described above, the techniques of the related art have problems that a double image or a defect of subjects occurs, and thus the viewing quality of panoramic images deteriorates.

The present invention has been made in view of this problem, and aims to provide a panoramic image generation device, a panoramic image generation method, and a panoramic image generation program capable of generating a panoramic image without a double image or a defect of a subject.

### Solution to Problem

A panoramic image generation device according to an aspect of the present invention includes an alignment processing unit that generates a panoramic image by combining a plurality of divided images captured by a plurality of imaging devices such that partial regions overlap, and generates a coordinate table in which coordinates of each of the divided images are associated with coordinates of the panoramic image; a luminance adjustment unit that refers to the coordinate table, obtains a luminance magnification indicating a ratio of luminance values of pixels of two divided images having an overlapping region, and generates a luminance adjustment coefficient that levels a luminance difference indicated by the luminance magnification; and an image combining unit that generates a panoramic image by adjusting the luminance difference between the divided images and combining the divided images by using the coordinate table, the luminance adjustment coefficient, and the divided images.

In addition, a panoramic image generation method according to an aspect of the present invention is a panoramic image generation method performed by the above-described panoramic image generation device, the method including an alignment processing step of generating a panoramic image by combining a plurality of divided images captured by a plurality of imaging devices such that partial regions overlap and generating a coordinate table in which coordinates of each of the divided images are associated with coordinates of the panoramic image, a luminance adjustment step of referring to the coordinate table, obtaining a luminance magnification indicating a ratio of luminance values of pixels of two divided images having an overlapping region, and generating a luminance adjustment coefficient that levels a luminance difference indicated by the luminance magnification, and an image combining step of generating a panoramic image by adjusting the luminance difference between the divided images and combining the divided images by using the coordinate table, the luminance adjustment coefficient, and the divided images.

Furthermore, a panoramic image generation program according to an aspect of the present invention is a panoramic image generation program for causing a computer to function as the panoramic image generation device.

### Advantageous Effects of Invention

According to the present invention, it is possible to generate a panoramic image without a double image or a defect of a subject.

### BRIEF DESCRIPTION OF DRAWINGS

FIG. 1 is a block diagram illustrating a functional configuration example of a panoramic image generation device according to an embodiment of the present invention.

FIG. 2 is a diagram illustrating an example of divided images in which a wide field of view in the horizontal direction is captured by four image sensors.

FIG. 3 is a diagram schematically illustrating a correspondence relationship of three kinds of coordinates of an output image obtained by dividing coordinates of divided images, coordinates of a combination buffer representing coordinates of one panoramic image obtained by superimposing parts of the divided images, and coordinates of the combination buffer in accordance with a video signal transmission standard.

FIG. 4 shows views showing an example of a panoramic image, FIG. 4 (a) is a view with no luminance adjustment, FIG. 4 (b) is a view with matched luminance of the divided images, and FIG. 4 (c) is a view with gradually matched luminance of the divided images.

FIG. 5 is waveforms representing the transition of RGB values corresponding to FIG. 4.

FIG. 6 is a diagram illustrating overlapping regions of divided images.

FIG. 7 is a diagram illustrating waveforms in which RGB signals shown in FIG. 4 are corrected and combined to match each other.

FIG. 8 is waveforms representing the transition of luminance obtained by gradually correcting and combining luminance differences of the four divided images.

FIG. 9 is a flowchart showing a processing procedure of the panoramic image generation device illustrated in FIG. 1.

FIG. 10 is a flowchart showing a processing procedure of the luminance adjustment unit illustrated in FIG. 1.

FIG. 11 is a block diagram illustrating a configuration example of a general-purpose computer system.

### DESCRIPTION OF EMBODIMENTS

Hereinbelow, embodiments of the present invention are described with reference to the drawings. The same components in the plurality of drawings will be denoted by the same reference signs, and description thereof will be omitted.

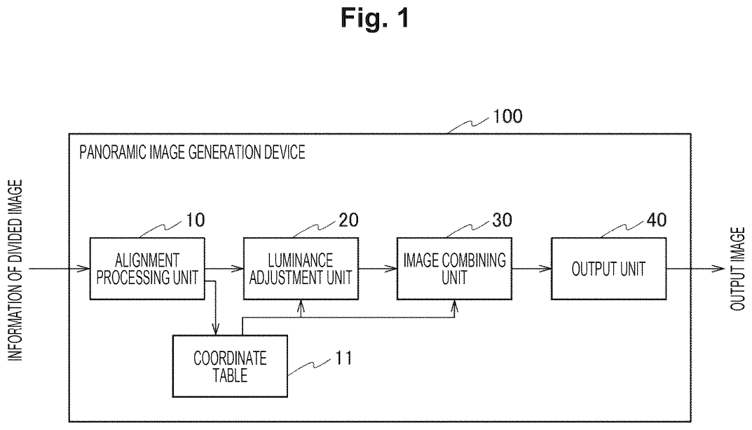

FIG. 1 is a block diagram illustrating a functional configuration example of a panoramic image generation device according to an embodiment of the present invention. A panoramic image generation device 100 illustrated in FIG. 1 is a device that generates a panoramic image by combining a plurality of divided images captured by a plurality of imaging devices such that partial regions thereof overlap.

The panoramic image generation device 100 includes an alignment processing unit 10, a luminance adjustment unit 20, an image combining unit 30, and an output unit 40. Hereinafter, each of the functional blocks will be described in detail with reference to the drawings.

### [Alignment Processing Unit]

The alignment processing unit 10 generates a panoramic image by combining a plurality of divided images captured by a plurality of imaging devices such that partial regions overlap, and generates a coordinate table in which coordinates of each of the divided images are associated with coordinates of the panoramic image. Next, divided images will be described.

### (Divided Image)

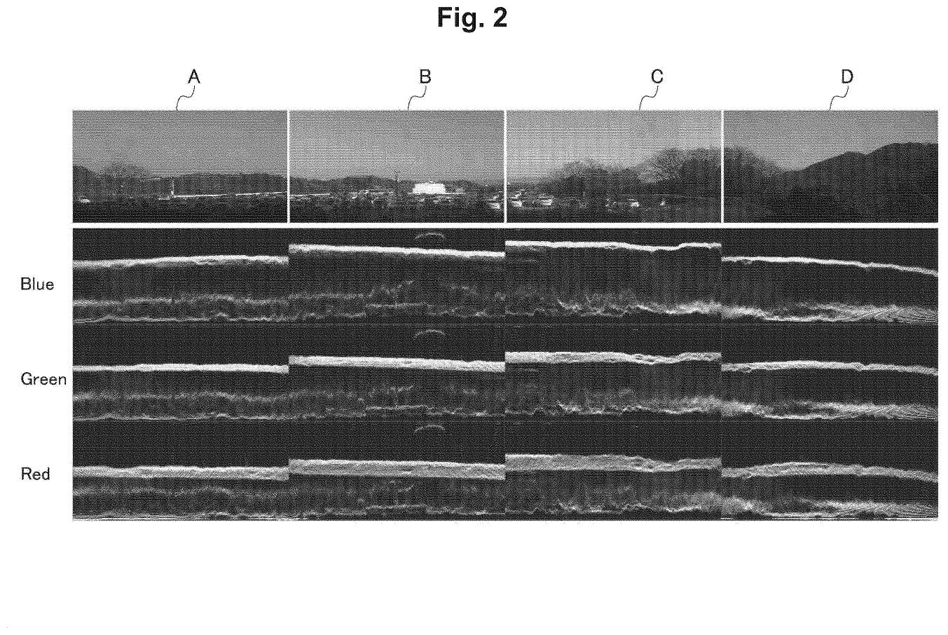

FIG. 2 illustrates an example of divided images in which one object is captured to be wide in the horizontal direction by four different imaging elements (also referred to as image sensors (not illustrated)). The uppermost section shows diagrams of images obtained by converting each of divided images A to D.

The three lower sections from the bottom are waveforms indicating the transition of luminance of each channel of RGB signals of the image sensors (not illustrated) corresponding to each of the divided images A to D. In this example, imaging conditions for the image sensors are not set to be equal.

As illustrated in FIG. 2, it can be seen that the average luminance dims in the horizontal direction, and the image sensors have different characteristics. The dimming in the horizontal direction is referred to as peripheral dimming, and occurs along the periphery of the lens end of the lens arranged in front of the image sensors. The divided images differ depending on characteristics of the image sensors as described above. Next, the coordinate table will be described.

### (Coordinate Table)

The coordinate table 11 is a table in which coordinates of each of the divided images are associated with coordinates of a panoramic image obtained by combining the divided images.

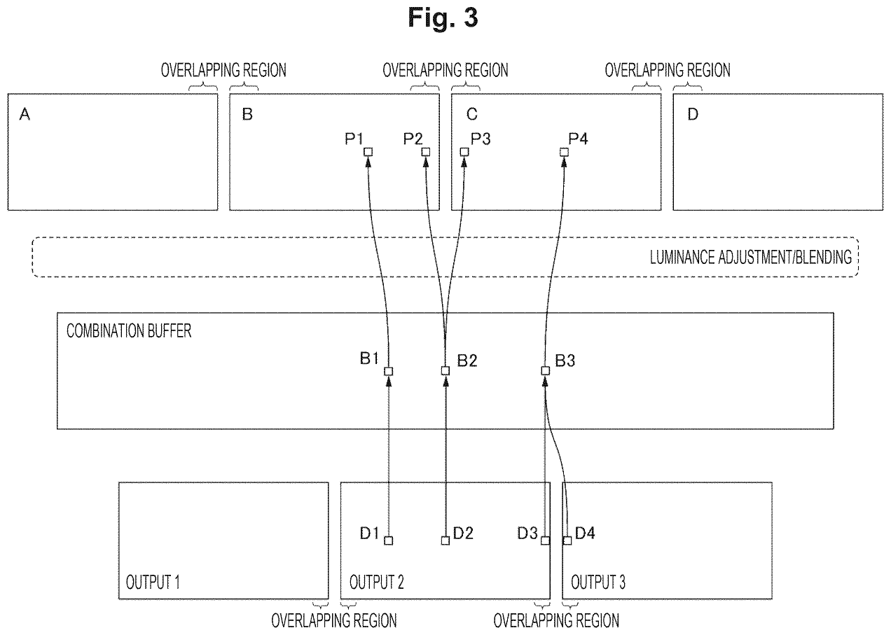

FIG. 3 is a diagram schematically illustrating a correspondence relationship of some of the three coordinates. Coordinates of each of the plurality of divided images are shown in the uppermost section of FIG. 3. The divided images have overlapping regions at one end or both ends thereof in the horizontal direction in this example. An overlapping region is a range in which two divided images overlap, and a width of the region is determined by the user.

The broken-line frame in the second section from the top of FIG. 3 indicates that the luminance value of the overlapping region is adjusted by the luminance adjustment unit 20.

The third section from the top of FIG. 3 schematically shows coordinates of a panoramic image obtained by overlapping each of the divided images in overlapping regions. The coordinates of the panoramic image are referred to as a combination buffer. A width of the combination buffer in the horizontal direction is as narrower as the overlapping regions of the divided images. The height direction thereof is the same as that of the divided images.

The coordinate table 11 is a table in which coordinates of each of the divided images A to D shown in the first section from the top of FIG. 3 are associated with those of the panoramic image (combination buffer) shown in the third section.

The lowermost section in FIG. 3 schematically shows coordinates of output images output by the output unit 40. The output unit 40 generates output images obtained by dividing the panoramic image output by the image combining unit 30, and associates the coordinates of the output images with the coordinates of the panoramic image using the coordinate table 11.

The coordinates of the output images differ depending on, for example, the video signal transmission standard of a projector to which the panoramic image generation device 100 is connected. In the example illustrated in FIG. 3, a width narrower than the coordinate range of the combination buffer is divided into three output images. The number of output images and overlapping regions differ depending on the number and function of devices that display the output images.

The luminance value of a pixel P4 of the divided image C illustrated in FIG. 3 is transcribed to a coordinate B3 of the combination buffer, and the luminance value of the coordinate B3 is further transcribed to a coordinate D3 of “output 2” of the output image and a coordinate D4 of “output 3” of the output image. The luminance value transcribed in this manner may be traced back from the output image side.

When the luminance value is traced back from the output image side, it is known from the coordinate table 11 that the luminance values of the coordinates D3 and D4 are the same, for example, and thus if the luminance value of the coordinate D4 of the “output 3” of the output image is referred to, it is not necessary to trace the pixel 4 back to the combination buffer and the divided image.

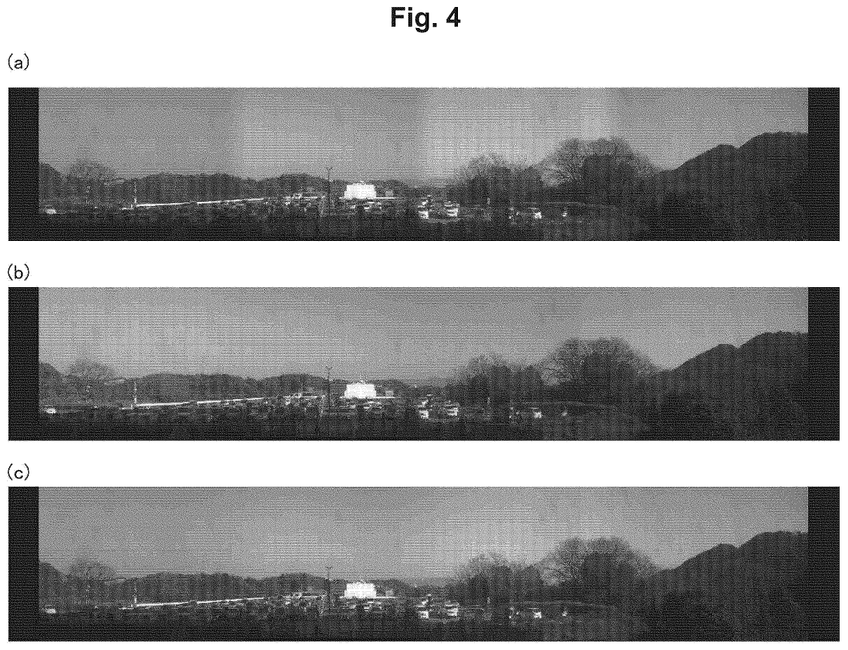

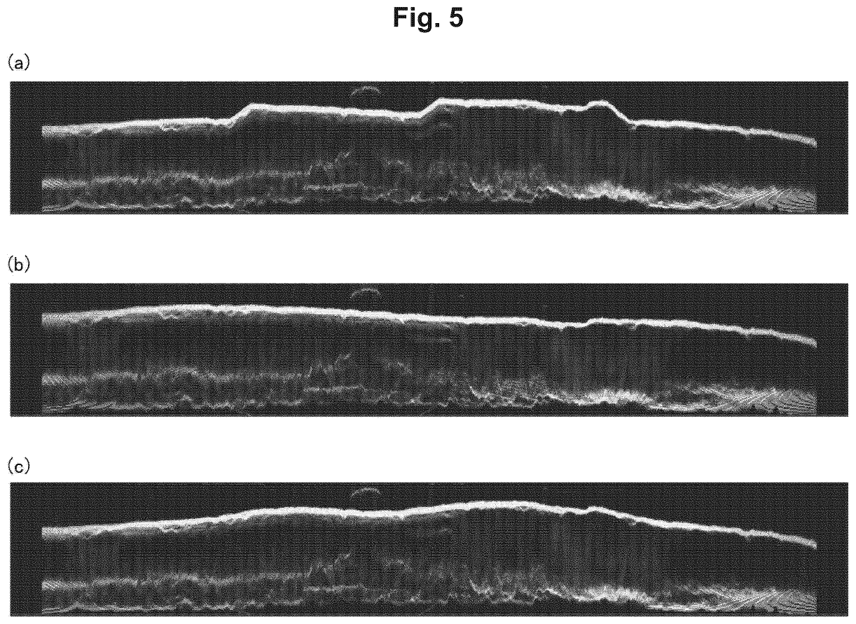

FIG. 4 is a diagram showing an example of images with luminance values of the combination buffer converted into a pixel value. FIG. 5 is a waveform representing the transition of luminance values of the combination value corresponding to FIG. 4.

The panoramic image (a) in the upper section of FIG. 4 is an image in which unevenness in luminance to be dimmed in the horizontal direction is not leveled. As shown in FIG. 4 (a) and FIG. 5 (a), the luminance of the overlapping region significantly changes.

The panoramic image (b) in the middle section of FIG. 4 is an image in which the luminance has been adjusted in a “matching mode”. As shown in FIG. 4 (b) and FIG. 5 (b), the luminance is so uniform that the luminance difference between the overlapping regions cannot be visually recognized.

The panoramic image in the lower section of FIG. 4 is an image in which the luminance has been adjusted in a “curving mode”. As shown in FIG. 4 (c) and FIG. 5 (c), the luminance of the overlapping regions gradually changes. On the other hand, the outside of the overlapping regions holds the luminance that is equal to the non-adjusted luminance.

The “matching mode” and the “curving mode” will be described later in detail.

### [Luminance Adjustment Unit]

The luminance adjustment unit 20 refers to the coordinate table 11, obtains a luminance magnification indicating a ratio of the luminance values of the pixels of each of the two corresponding divided images, and generates a luminance adjustment coefficient for leveling the luminance difference indicated by the luminance magnification.

Here, an overlapping region of divided images will be described.

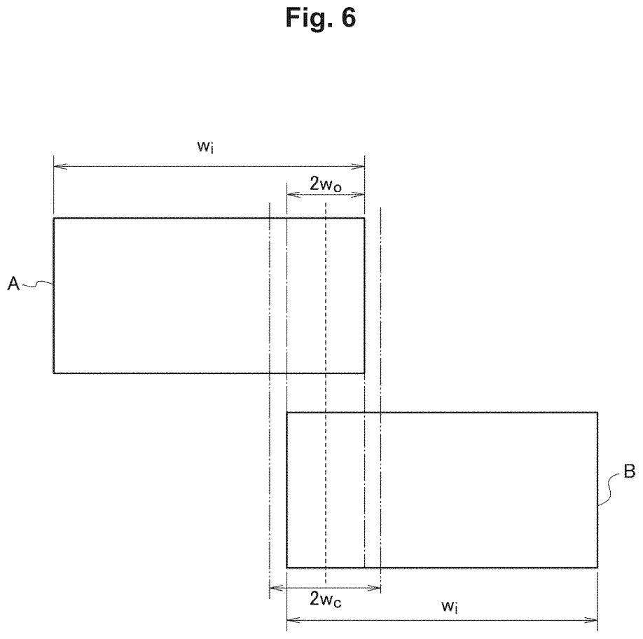

FIG. 6 is a diagram schematically illustrating an overlapping region between the divided images A and B. An image width of the divided images A and B in the x direction is denoted by wᵢ, a width of half the width of the overlapping region is denoted by wₒ, and a width of half the range for adjusting luminance is denoted by w_{c}. The divided image C has the same overlapping regions between the divided image C and the divided image B and between the divided image C and the divided image D. The same applies to the divided image D.

The luminance values of the divided images A to D are, for example, 1920×1080 in 2K resolution. Thus, when the luminance values respectively corresponding to the pixel (x₀, Y₁₀₀) of the divided image B overlapping the pixel (x_{1920-2wo}, Y₁₀₀) of the divided image A in the overlapping region 2wₒ are represented as Y_{A} (x_{1920-2wo}, y₁₀₀) and Y_{S}(x₀, y₁₀₀), the luminance magnification is Y_{A} (x_{1920-2wo}, y₁₀₀)/Y_{S}(x₀, y₁₀₀).

The luminance magnification Y_{A}/Y_{B} may be obtained for each pixel, or a plurality of sets of coordinates in the overlapping region 2wₒ. of different divided images may be randomly sampled, and the luminance adjustment coefficient Y_{A}/Y_{B} may be obtained from the average value thereof. However, when the luminance value of any pixel of the divided images is 0 or saturated, the luminance value is assumed to be excluded.

For example, in a case where the average luminance magnification of an N-th divided image is Mₐᵥₑ, and the luminance magnification between the N-th divided image and the (N+1)-th divided image is M_{N+1}, the divided image in the (N+1)-th overlapping region may be adjusted by multiplying the divided image (luminance value) in the overlapping region by a luminance adjustment coefficient (Mₐᵥₑ/M_{N+1}). That is, the luminance adjustment coefficient is, for example, a reciprocal of the luminance magnification. Consequently, the luminance in the N-th and (N+1)-th overlapping regions can be matched.

As a method of matching luminance, for example, an operation in the “matching mode” to eliminate the difference in the average luminance between the divided images can be considered. The range in which luminance adjustment is performed in the “matching mode” may be either within the range of the overlapping region 2wₒ or the entire range of the divided images. That is, the luminance adjustment unit 20 calculates a luminance adjustment coefficient for adjusting the luminance difference between the divided images in the overlapping regions of the divided images, and adjusts the luminance difference between the divided images.

Furthermore, the luminance difference between the divided images may be adjusted in the “curving mode” in which the luminance is gradually curved. The luminance adjustment coefficient in the “curving mode” can be expressed by, for example, the following formula.

$$[ Math . 1 ]$$

$$1. + \frac{\frac{{M}_{B}}{{M}_{A}} - 1.0}{2} ( 1. - cos ( \frac{π}{2} \times \frac{( x - ( {w}_{i} - {w}_{o} - {w}_{c} ) )}{{w}_{c}} ) ) \qquad ( 1 )$$

Here, M_{A} is the luminance magnification of the divided image A, M_{B} is the luminance magnification of the divided image B overlapping on the right side of the divided image A, wᵢ is the image width of the divided image, wₒ is the width of half the width of the overlapping region, and w_{c} is the width of half the width for adjusting the luminance to be gentle (curved).

The luminance adjustment coefficient for the divided images can be expressed by the following formula.

$$[ Math . 2 ]$$

$$1. + \frac{\frac{{M}_{B}}{{M}_{A}} - 1.0}{2} ( 1. - cos ( \frac{π}{2} \times \frac{( ( {w}_{o} - {w}_{c} ) - x )}{{w}_{c}} ) ) \qquad ( 2 )$$

These luminance adjustment coefficients are applied only to luminance values within a range in which the luminance of the overlapping regions is gradually adjusted. As described above, the luminance adjustment coefficients may be expressed by a function that gradually adjusts the luminance difference between the divided images. Further, a cosine function representing a luminance adjustment coefficient may be a sine function or a polynomial function.

Formulas (1) and (2) are based on the assumption that a divided image is obtained by dividing an image in the horizontal direction (x). In the case where an image is divided in the horizontal direction or divided in a square lattice shape in the horizontal and vertical directions, the corresponding coordinates (y coordinates in the vertical direction) and the width of the overlapping region are referred to in the same formula as above.

### [Image Combining Unit]

The image combining unit 30 uses the coordinate table 11, the luminance adjustment coefficients, and the divided images to generate a panoramic image in which the luminance difference between the divided images has been adjusted.

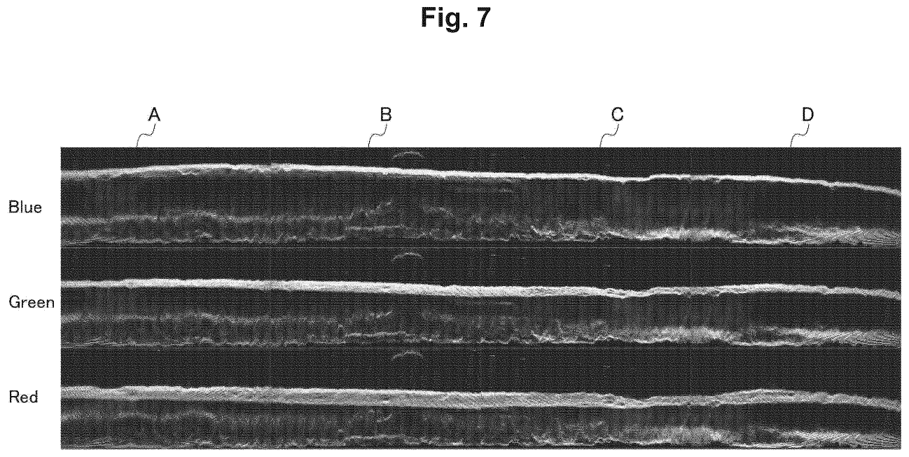

FIG. 7 is a waveform showing the transition of the luminance obtained by matching the RGB signals illustrated in FIG. 2 in the “matching mode” using the luminance adjustment coefficients. As shown in FIG. 7, the level differences in the average luminance of the divided images have been eliminated, and the luminance of the portions is matched.

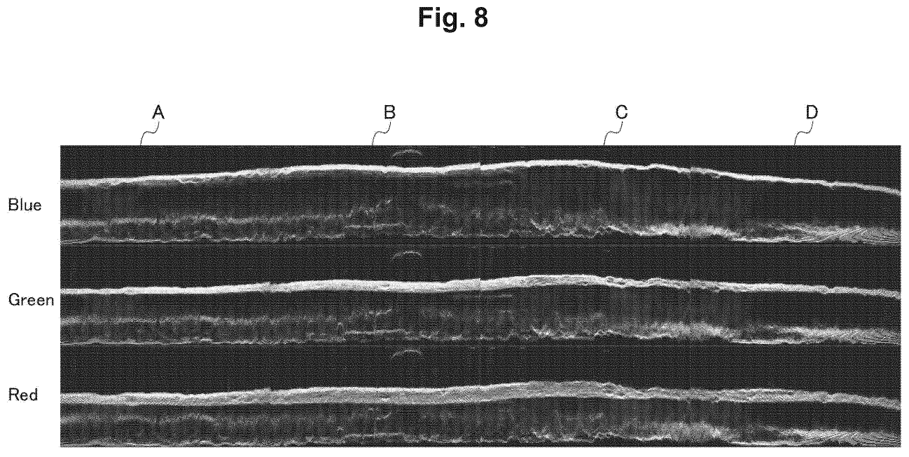

FIG. 8 is a waveform showing the transition of the luminance obtained by matching the RGB signals shown in FIG. 7 in the “curving mode”. The RGB signals corresponding to the divided images in this case change gradually and match.

In the “curving mode”, in a certain section (in this example, the range of the x coordinate) determined by the user from the center of the overlapping region between the divided images, the luminance magnification corresponding to the coordinate is applied.

The luminance adjustment coefficients according to the present embodiment are obtained from the divided images captured by the plurality of imaging devices such that the partial regions overlap. Therefore, there is no parallax between the divided images. As a result, the luminance adjustment coefficients do not unintentionally change due to the camerawork or movement of the subject, and thus stable operations can be expected.

### [Output Unit]

The output unit 40 generates output images obtained by dividing the panoramic image output by the image combining unit 30, and associates the coordinates of the output images with the coordinates of the panoramic image using the coordinate table 11. The output images output by the output unit 40 vary depending on a specification of an image display device (not illustrated) to which the panoramic image generation device 100 is connected. The specification may be, for example, any of serial digital interface (SDI) output conforming to a video signal transmission standard, image output conforming to a moving image compression standard, image output defined by an Internet service provider (ISP), and the like.

The output unit 40 associates the coordinates of the panoramic image (the image held in the “combination buffer” in FIG. 3) with the coordinates of the output images. Thus, when the coordinate table 11 is referred to, the coordinates of the output images can be traced back to the coordinates of the divided images.

As described above, the panoramic image generation device 100 according to the present embodiment includes the alignment processing unit 10 that generates a panoramic image by combining the plurality of divided images A to D captured by a plurality of imaging devices such that partial regions overlap, and generates the coordinate table 11 in which the coordinates of each of the divided images A to D are associated with the coordinates of the panoramic image; the luminance adjustment unit 20 that refers to the coordinate table 11, obtains a luminance magnification indicating a ratio of luminance values of pixels of two (A and B, B and C, C and D) divided images having an overlapping region, and generates a luminance adjustment coefficient that levels a luminance difference indicated by the luminance magnification; and the image combining unit 30 that generates a panoramic image by adjusting the luminance difference between the divided images A to D and combining the divided images by using the coordinate table 11, the luminance adjustment coefficient, and the divided images. As a result, it is possible to generate a panoramic image signal without a double image or a defect of a subject, and to improve the viewing quality of the panoramic image.

In addition, the panoramic image generation device 100 includes the output unit 40, the output unit 40 generates output images obtained by dividing the panoramic image output by the image combining unit 30, and associates the coordinates of the output images with the coordinates of the panoramic image using the coordinate table 11. As a result, the panoramic image can be output to an arbitrary image display device connected to the panoramic image generation device 100.

In addition, the luminance adjustment coefficient is a reciprocal of the luminance magnification, and the luminance adjustment coefficient is multiplied by all of the overlapping regions or the divided images to be combined. As a result, the luminance difference between different divided images can be eliminated.

In addition, the luminance adjustment coefficient is indicated by a function that gradually adjusts a luminance difference of a range including the overlapping regions of the divided images and not exceeding the divided images. As a result, the luminance difference in the range including the overlapping regions and not exceeding the divided image is gradually adjusted, and the original luminance is maintained outside the range. That is, each image sensor can generate a panoramic image with optimized settings. Therefore, over-exposing or under-exposing of the subject outside the overlapping region does not occur.

### (Panoramic Image Generation Method)

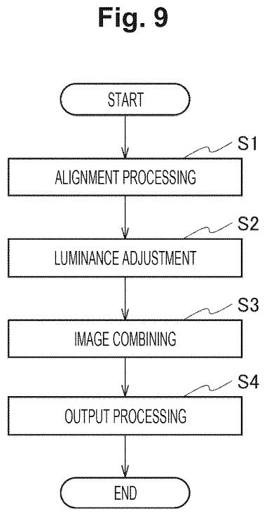

FIG. 9 is a flowchart showing a processing procedure of a panoramic image generation method performed by the panoramic image generation device 100 according to the present invention.

When the panoramic image generation device 100 starts an operation, first, the alignment processing unit 10 acquires divided images captured by a plurality of imaging devices such that partial regions thereof overlap. The divided images may be any of information of images captured by an imaging device such as a camera, a signal of a video captured by a video device, information of an image output by a device capable of reproducing a recorded image, and information of image acquired from an Internet Service Provider (ISP) that outputs information of an image by an image sensor. When a synchronization signal is obtained, the synchronization signal is also acquired at the same time.

Next, the alignment processing unit 10 generates a panoramic image by combining the plurality of acquired divided images and generates the coordinate table 11 in which coordinates of each of the divided images are associated with coordinates of the panoramic image (step S1).

Next, the luminance adjustment unit 20 refers to the coordinate table 11, obtains a luminance magnification indicating a ratio of luminance values of pixels of two divided images having overlapping regions, and generates a luminance adjustment coefficient for leveling the luminance difference indicated by the luminance magnification (step S2).

Next, the image combining unit 30 uses the coordinate table 11, the luminance adjustment coefficient, and the divided images to generate a panoramic image obtained by adjusting the luminance difference between the divided images and combining the divided images (step S3). Next, the output unit 40 generates an output image obtained by dividing the panoramic image output by the image combining unit (step S4). The output image is divided into, for example, a plurality of serial digital interface (SDI) outputs (output image information) conforming to a video signal transmission standard and then output.

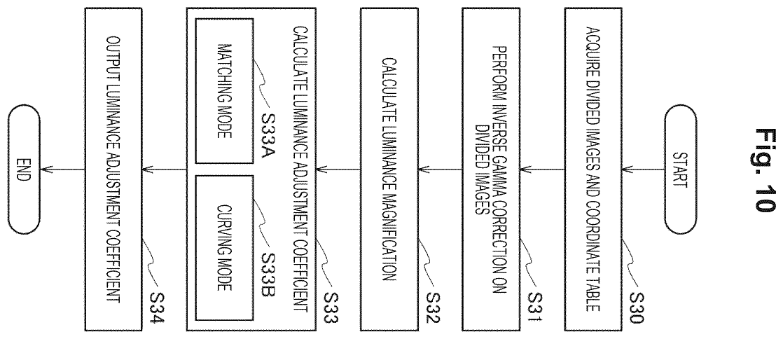

FIG. 10 is a flowchart showing a processing procedure performed by the luminance adjustment unit 20. An operation thereof is described with reference to FIG. 10.

The luminance adjustment unit 20 first acquires the divided images and the coordinate table 11 from the alignment processing unit 10 (step S30).

Next, the luminance adjustment unit 20 converts pixel values of the divided images into the luminance values based on the setting of the image sensors that have acquired the divided images or the operation of the user (step S31).

Next, the luminance adjustment unit 20 refers to the coordinate table 11 and calculates a luminance magnification indicating a ratio of the luminance values of pixels of two divided images having an overlapping region (step S32).

Next, based on the luminance magnification, the luminance adjustment unit 20 calculates a luminance adjustment coefficient for leveling the luminance difference between the divided images by using either method of the above-described “matching mode (step S33A)” or “curving mode (step S33B)” (step S33).

Then, the luminance adjustment unit 20 outputs the luminance adjustment coefficient to the image combining unit 30 (step S34).

The processing from step S30 to step S34 is executed for each frame of the divided images.

As described above, the panoramic image generation method according to the present embodiment is a the panoramic image generation method performed by the panoramic image generation device 100, and the method includes an alignment processing step of generating the coordinate table 11 in which coordinates of each of divided images, which are captured by a plurality of imaging devices such that partial regions overlap, are associated with coordinates of a panoramic image obtained by combining the divided images with the divided images as an input; a luminance adjustment step of referring to the coordinate table 11 to obtain a luminance magnification indicating a ratio of luminance values of pixels of two corresponding divided images and generate a luminance adjustment coefficient that levels a luminance difference indicated by the luminance magnification; an image combining step of generating a panoramic image by adjusting the luminance difference between the divided images and combining the divided images by using the coordinate table 11, the luminance adjustment coefficient, and the divided images; and an output step of generating an output image obtained by dividing the panoramic image obtained from the combination in the image combining step. With this configuration, it is possible to generate a panoramic image signal without a double image or a defect of a subject.

According to the present invention, it is possible to provide a technique for curbing quality deterioration in a boundary portion at the time of combination for the panoramic image caused by a change in luminance between image sensors caused by a difference in the setting values of adjacent image sensors, such as a case where the settings of a plurality of image sensors are automatically set in generation of a panoramic image. In addition, even if there is a variation in luminance due to individual differences between the image sensors that may occur when the settings of the plurality of image sensors are unified, it is possible to curb quality deterioration in the boundary portion of the divided images.

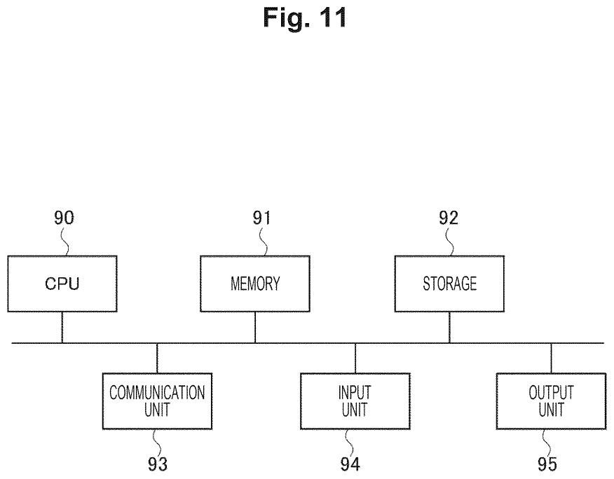

The panoramic image generation device 100 can be implemented by a general-purpose computer system illustrated in FIG. 11. For example, in a general-purpose computer system including a CPU 90, a memory 91, a storage 92, a communication unit 93, an input unit 94, and an output unit 95, the CPU 90 executing a predetermined program loaded on the memory 91 realizes each function of the panoramic image generation device 100. The predetermined program can be recorded on a computer-readable recording medium such as an HDD, an SSD, a USB memory, a CD-ROM, a DVD-ROM, or an MO, or can be distributed via a network. Further, a GPU may be used, without being limited to a CPU.

The present invention is not limited to the above embodiments, and modifications can be made within the scope of the gist of the present invention. For example, although the example of four divided images has been described, the present invention is not limited to this example. The number of divided images may be two or more. In addition, a direction in which an image is divided is not limited to the horizontal direction.

As described above, the present invention of course includes various embodiments and the like not described herein. Therefore, the technical scope of the present invention is defined only by matters to specify the invention according to the scope of claims pertinent based on the foregoing description.

### REFERENCE SIGNS LIST

10 Alignment processing unit
11 Coordinate table
20 Luminance adjustment unit
30 Image combining unit
40 Output unit
100 Panoramic image generation device

1. A panoramic image generation device comprising:
an alignment processing unit, including one or more processors, configured to generate a panoramic image by combining a plurality of divided images captured by a plurality of imaging devices such that partial regions overlap and generate a coordinate table in which coordinates of each of the divided images are associated with coordinates of the panoramic image;
a luminance adjustment unit, including one or more processors, configured to refer to the coordinate table, obtain a luminance magnification indicating a ratio of luminance values of pixels of two of the divided images having an overlapping region, and generate a luminance adjustment coefficient that levels a luminance difference indicated by the luminance magnification; and
an image combining unit, including one or more processors, configured to generate a panoramic image by adjusting the luminance difference between the divided images and combining the divided images by using the coordinate table, the luminance adjustment coefficient, and the divided images.

2. The panoramic image generation device according to claim 1, further comprising:
an output unit including one or more processors, wherein
the output unit is configured to generate an output image obtained by dividing the panoramic image output by the image combining unit, and associate coordinates of the output image with coordinate of the panoramic image using the coordinate table.

3. The panoramic image generation device according to claim 1, wherein
the luminance adjustment coefficient is a reciprocal of the luminance magnification, and the luminance adjustment coefficient is multiplied by all of overlapping regions of the divided images or the divided images.

4. The panoramic image generation device according to claim 1, wherein
the luminance adjustment coefficient is indicated by a function of gradually adjusting a luminance difference between the divided images.

5. A panoramic image generation method performed by a panoramic image generation device, the method comprising:
an alignment processing step of generating a panoramic image by combining a plurality of divided images captured by a plurality of imaging devices such that partial regions overlap and generating a coordinate table in which coordinates of each of the divided images are associated with coordinates of the panoramic image;
a luminance adjustment step of referring to the coordinate table, obtaining a luminance magnification indicating a ratio of luminance values of pixels of two of the divided images having an overlapping region, and generating a luminance adjustment coefficient that levels a luminance difference indicated by the luminance magnification; and
an image combining step of generating a panoramic image by adjusting the luminance difference between the divided images and combining the divided images by using the coordinate table, the luminance adjustment coefficient, and the divided images.

6. A non-transitory computer-readable storage medium storing a panoramic image generation program for causing a computer to perform operations comprising:
an alignment processing step of generating a panoramic image by combining a plurality of divided images captured by a plurality of imaging devices such that partial regions overlap and generating a coordinate table in which coordinates of each of the divided images are associated with coordinates of the panoramic image;
a luminance adjustment step of referring to the coordinate table, obtaining a luminance magnification indicating a ratio of luminance values of pixels of two of the divided images having an overlapping region, and generating a luminance adjustment coefficient that levels a luminance difference indicated by the luminance magnification; and
an image combining step of generating a panoramic image by adjusting the luminance difference between the divided images and combining the divided images by using the coordinate table, the luminance adjustment coefficient, and the divided images.

7. The panoramic image generation method according to claim 5, further comprising:
generating an output image obtained by dividing the panoramic image, and associating coordinates of the output image with coordinate of the panoramic image using the coordinate table.

8. The panoramic image generation method according to claim 5, wherein
the luminance adjustment coefficient is a reciprocal of the luminance magnification, and the luminance adjustment coefficient is multiplied by all of overlapping regions of the divided images or the divided images.

9. The panoramic image generation method according to claim 5, wherein
the luminance adjustment coefficient is indicated by a function of gradually adjusting a luminance difference between the divided images.

10. The non-transitory computer-readable storage medium according to claim 6, wherein the operations further comprise:
generating an output image obtained by dividing the panoramic image, and associating coordinates of the output image with coordinate of the panoramic image using the coordinate table.

11. The non-transitory computer-readable storage medium according to claim 6, wherein
the luminance adjustment coefficient is a reciprocal of the luminance magnification, and the luminance adjustment coefficient is multiplied by all of overlapping regions of the divided images or the divided images.

12. The non-transitory computer-readable storage medium according to claim 6, wherein
the luminance adjustment coefficient is indicated by a function of gradually adjusting a luminance difference between the divided images.
